(19) United States
(12) Patent Application Publication
(10) Pub. No.: US 2005/0242471 A1
(43) Pub. Date: Nov. 3, 2005

(54) Methods for continuously producing shaped articles

(76) Inventors: Sanjiv M. Bhatt, Minnetonka, MN (US); Charles W. Extrand, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/836,634

(22) Filed: Apr. 30, 2004

(51) Int. Cl. B23K 26/36; H01S 3/00

(52) U.S. Cl. 264/400; 264/129; 264/494; 264/485; 264/488

(57) ABSTRACT

Improved processes for forming shaped articles comprise extruding a composite comprising a polymer and at least one additive, and shaping the composite to form an article having a desired shape. Generally, the extruding and shaping steps are performed on a single process line, which allows the shaped articles to be produced in a continuous process. Due to the continuous process design, shaped articles made by the improved process can be produced in large quantities at a low cost per article. In some embodiments, a shaping station can be employed to shape the extruded composite. The shaping station can comprise a laser machining apparatus, a hot stamping apparatus, rollers having a predetermined pattern, or combinations thereof.

### FIELD OF THE INVENTION

The invention relates to processes for producing shaped articles such as, for example, bipolar plates, MEA/bipolar plate composites and the like. In particular, the invention relates to a method for forming shaped articles comprising extruding a composite comprising polymer and at least one additive, and forming the composite into a desired shape such that shaped articles are produced in a continuous process.

### BACKGROUND OF THE INVENTION

In general, a fuel cell is an electrochemical device that can convert energy stored in fuels such as hydrogen, oxygen, methanol and the like, into electricity without combustion of the fuel. A fuel cell generally comprises a negative electrode, a positive electrode, and a separator within an appropriate container. Fuel cells operate by utilizing chemical reactions that occur at each electrode. In general, electrons are generated at one electrode and flow through an external circuit to the other electrode where they replace electrons involved in reduction reactions. This flow of electrons creates an over-voltage between the two electrodes that can be used to drive useful work in the external circuit. In commercial embodiments, several “fuel cells” are usually arranged in series, or stacked, in order to create larger over-potentials. Individual “fuel cells,” which can comprise an anode, a cathode and a separator between the anode and the cathode, can be connected to adjacent cells by, for example, a bipolar plate. Bipolar plates for use in fuel cell applications are conductive and generally comprise structure on the surface of the plate which define flow paths along the surface of the plate. The flow paths can facilitate the delivery of, for example, reactants to the electrode assemblies.

A fuel cell is similar to a battery in that both generally have a positive electrode, a negative electrode and electrolytes. However, a fuel cell is different from a battery in the sense that the fuel in a fuel cell can be replaced without disassembling the cell to keep the cell operating. Additionally, fuel cells have several advantages over other sources of power that make them attractive alternatives to traditional energy sources. Specifically, fuel cells are environmentally friendly, efficient and utilize convenient fuel sources, for example, hydrogen or methanol.

Fuel cells have potential uses in a number of commercial applications and industries. For example, fuel cells are being developed that can provide sufficient power to meet the energy demands of a single family home. In addition, prototype cars have been developed that run off of energy derived from fuel cells. Furthermore, fuel cells can be used to power portable electronic devices such as computers, phones, video projection equipment and the like. Fuel cells designed for use with portable electronic equipment provide an alternative to battery power with the ability to replace the fuel without replacing the whole cell. Additionally, fuel cells can have longer power cycles and no down time for recharging, which also makes fuel cells an attractive alternative to battery power for portable electronics.

In general, fuel cell components such as bipolar plates can be composed of polymer composites. Generally, the polymer composites can be formed and shaped to produce shaped articles such as bipolar plates. The shaping process for producing bipolar plates comprising polymer composites can involve a compression or injection molding step, which involves transporting the formed composite to a suitable molding apparatus where heat and/or pressure can be applied to the composite to introduce desired shape into the composite.

### SUMMARY OF THE INVENTION

In a first aspect, the invention pertains to a method for forming shaped articles, the method comprising extruding a composite web having a first surface and a second surface, the composite web comprising polymer and at least one conductive additive. In these embodiments, the method can further comprise laser machining the composite web such that desired shaped is formed into at least one surface of the composite web.

In a second aspect, the invention relates to a method for forming a bipolar plate for a fuel cell. In these embodiments, the method can comprise laser machining a continuous web of a polymer/conductive polymer additive composite to form first flow channels on a surface of the composite web, wherein the polymer/conductive polymer additive composite comprises a first surface and a second surface, and wherein the first flow channels are formed into the first surface.

In another aspect, the invention relates to a method for forming a bipolar plate for a fuel cell. In these embodiments, the method can comprise hot stamping a continuous web of a polymer/conductive polymer additive composite to form first flow channels on a surface of the composite web, wherein the polymer/conductive polymer additive composite comprises a first surface and a second surface, and wherein the first flow channels are formed into the first surface.

In a further aspect, the invention relates to a method for forming a composite structure for a fuel cell comprising extruding a plurality of composite layers, wherein the plurality of composite layers each comprise a conductive additive and a polymeric binder and forming flow channels on the surface of at least one of the plurality of composite layers. In these embodiments, the method can further comprise combining the plurality of composite layers to form a multi-layer bipolar plate, and extruding a membrane electrode assembly, wherein the membrane electrode assembly comprises an anode, a cathode and a separator between the anode and the cathode. Additionally, the method can comprise combining the multi-layer bipolar plate and the membrane electrode assembly to form a membrane electrode assembly/bipolar plate composite.

### BRIEF DESCRIPTION OF THE FIGURES

FIG. 1 is a schematic diagram of an embodiment of a process line comprising and extruder and a shaping station.

FIG. 2 is a schematic diagram of an embodiment of a process line comprising a plurality of first stage extruders and a second stage extruder.

FIG. 3 is a cross-sectional view of a multi-layered composite formed by the processes of the present disclosure.

FIG. 4 is a schematic diagram of a laser machining apparatus suitable for use in the process lines of the present disclosure.

FIG. 5 is a schematic diagram of a hot stamping apparatus suitable for use in the process lines of the present disclosure.

### DETAILED DESCRIPTION OF THE INVENTION

Improved processes for forming shaped articles comprise extruding a composite comprising a polymer and at least one additive, and shaping the composite to form an article having a desired shape. Generally, the extruding and shaping steps are performed on a single process line, which allows the shaped articles to be produced in a continuous process. Due to the continuous process design, shaped articles made by the improved process can be produced in large quantities at a low cost per article. In some embodiments, a shaping station can be employed to shape the extruded composite. The shaping station can comprise a laser machining apparatus, a hot stamping apparatus, rollers having a predetermined pattern, or combinations thereof. Additionally, a surface treatment station can be located along the process line, which can facilitate, for example, applying surface coatings and/or cross-linking of the extruded composite during production of the shaped article. Additionally or alternatively, additives such as electrically conductive particulates, can be introduced into the extruder to form polymer/conductive polymer additive composites. In some embodiments, the electrically conductive additive can comprise conductive fibers that increase the mechanical strength and/or electrical conductivity of the composite. In some embodiments, the shaped article can comprise a bipolar plate suitable for use in fuel cell applications, while in further embodiments the bipolar plate can be also associated with a membrane electrode assembly.

As described above, a fuel cell is a device that can convert chemical energy into electricity. Generally, the voltage that can be generated by an individual fuel cell is low, on the order of about 0.7V. As a result, commercially useful fuel cells typically have numerous fuel cells electrically connected in series to form a fuel cell stack. One way of electrically connecting fuel cells in series is to place a bipolar plate between the cathode of one fuel cell and the anode of an adjacent fuel cell. In general, bipolar plates suitable for use in fuel cell applications are electrically conductive, and also generally have structure that facilitates the delivery of reactants to the electrodes. In some embodiments, the structure can comprise grooves or channels formed into the surface of the bipolar plates, which can provide flow pathways for liquids and/or gases to desired surfaces of the electrode assemblies.

Bipolar plates can be composed of stainless steel, graphite blocks or can be formed from polymers loaded with conductive particles, such as conductive carbon. However, stainless steel bipolar plates can be expensive to manufacture due to the difficulty of shaping and machining metal. In addition, bipolar plates composed of polymer/conductive particle composites can be formed by injection molding or compression molding, which can require the composite composition to be transferred to the molding equipment to shape the composite. The manufacture of the bipolar plates using a continuously produced web can provide significant processing efficiencies relative to molding processes that are based on batch production in a mold to form the shaped article. Furthermore, shaping processes such as injection molding can be relatively slow, which can increase the time required to produced shaped articles. Due to the increasing demand for fuel cells, and fuel cell components, it would be desirable to provide a method of producing shaped articles such as, for example, bipolar plates which can reduce the production time and costs of manufacturing shaped articles. As described herein, one way producing large quantities of shaped articles at a low cost per article is to employ a single process line in which a composite is formed and shaped into a desired article in a continuous process.

In some embodiments, the method of the present disclosure comprises introducing a polymer and one or more additives into an extruder and applying shear forces to form a polymer/additive composite. The polymer/additive composite can be extruded and directed to a shaping station located on the process line, which can introduced desired shape on one or more surfaces of the extruded composite, generally to form flow channels for the resulting bipolar plate. The shaping stations employed in the process lines of the present disclosure facilitate the continuous shaping of the composite as the composite is fed from the extruder, which allows shaped articles such as, for example, bipolar plates to be produced on a single process line without the need for transferring the formed composite to a separate shaping station. Producing shaped article in a continuous process can reduce the time and the manufacturing costs associated with producing articles such as bipolar plates.

In some embodiments, the methods of the present disclosure can further comprise a surface treatment step. In these embodiments, the process line can comprise one or more surface treatment stations, which can facilitate, for example, applying surface coatings, such as, for example, a conductive coating, a fluoropolymer coating or a coating to improve the lyophilicity of the composite, and/or cross-linking a surface of the composite. Additionally, the process line can comprise a stamp out and a packaging station, which can cut or stamp out the shaped portion of the extruded composite web to form a shaped article, and subsequently package the shaped article in a suitable container.

In another embodiment, the method of the present disclosure comprises a process for producing a composite structure having a bipolar plate associated with a membrane electrode assembly. In these embodiments, the bipolar plate can comprise a plurality of composite layers that are co-extruded, shaped and combined to form a multi-layer bipolar plate structure. Additionally, a membrane electrode assembly, comprising an anode, a cathode and a separator located between the anode and the cathode, can be extruded and combined with a bipolar plate structure to form a membrane electrode assembly/bipolar plate composite. In these embodiments, the continuous forming and shaping process design can reduce the time and expenses associated with producing the bipolar plate/membrane electrode assembly composites. Additionally, combining the bipolar plate with the membrane electrode assembly can facilitate easier formation of fuel cell stacks, since the bipolar plate is already attached to one of the electrode assemblies.

Process Lines for Forming Shaped Articles

In general, the processes of the present disclosure comprise forming a polymer/additive composite as a continuous web and subsequently shaping the polymer/additive composite along the web to form a shaped article such as a bipolar plate. The forming and shaping steps are generally performed in a continuous manner, which can reduce the time and expense associated with producing shaped articles. In some embodiments, additives, such as electrically conductive particulates, a continuous fiber or the like, can be added to the polymer/additive composite to increase the mechanical strength and/or electrical conductivity of the composite. Additionally, the process lines of the present disclosure can comprise a surface treatment station which can facilitate applying a surface treatment such as, for example, a surface coating to the polymer/additive composites.

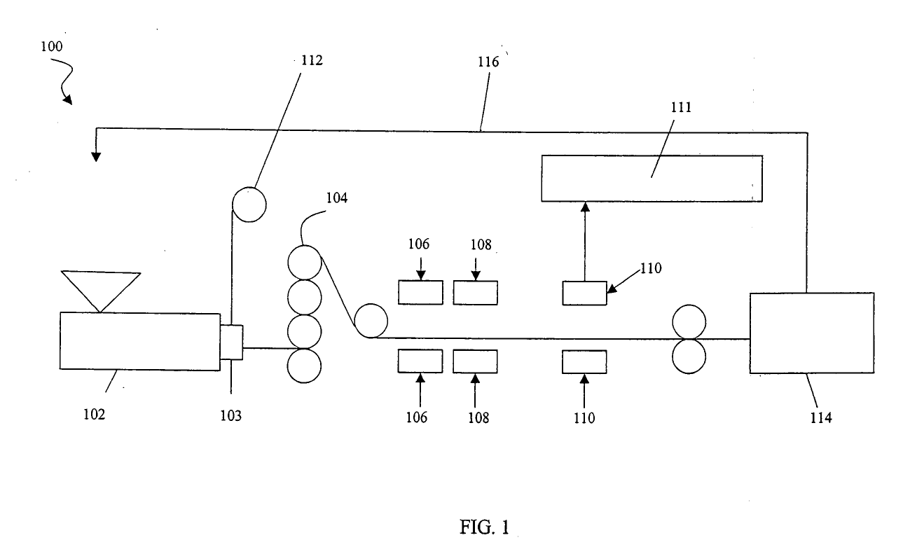

Referring to FIG. 1, an embodiment of a process line 100 that can be used for the methods of the present disclosure is shown comprising extruder 102, cooling station 104, shaping station 106, surface treatment station 108, stamp out station 110 and packaging station 111. Element 114 is a grinder for recycling unused composite. Additionally, optional additive feed 112 can be provided to feed a conductive additive, such as electrically conductive fiber, into the extruder barrel. In some embodiments, the conductive fiber can be introduced into one end of extruder die 103 and can be pulled through the other end of the die, which can facilitate interweaving and impregnating the fiber into the composite web. In some embodiments, process line 100 can further comprise grinder 114 and regrind loop 116, which facilitates recycling of unused process materials back into extruder 102.

Generally, polymer and one or more additives can be introduced into extruder 102, which facilitates the formation of a polymer/additive composite. The polymer and the additive can be introduced into extruder 102 by appropriate process equipment such as, for example, a hopper or the like. The composite can then be extruded as a web that is directed to the other stations of the processing line. Additionally, process line 100 can optionally comprise one more surface treatment stations 108, which can facilitate applying a surface treatment to one or more surfaces of the extruded composite. In some embodiments, process line 100 can also comprise stamp out station 110, which can remove, or stamp out, the shaped portion of the extruded composite to form the final shaped article. Additionally, packaging station 111 can facilitate packaging of the shaped article into an appropriate container. The processing equipment is described further below.

As shown in FIG. 1, the extruded composite can be formed and shaped in a continuous manner, which eliminates the need to transfer the formed composite to a separate process line. As described above, forming and shaping a composite into a shaped article in a continuous manner can reduce the time and expense associated with producing shaped articles.

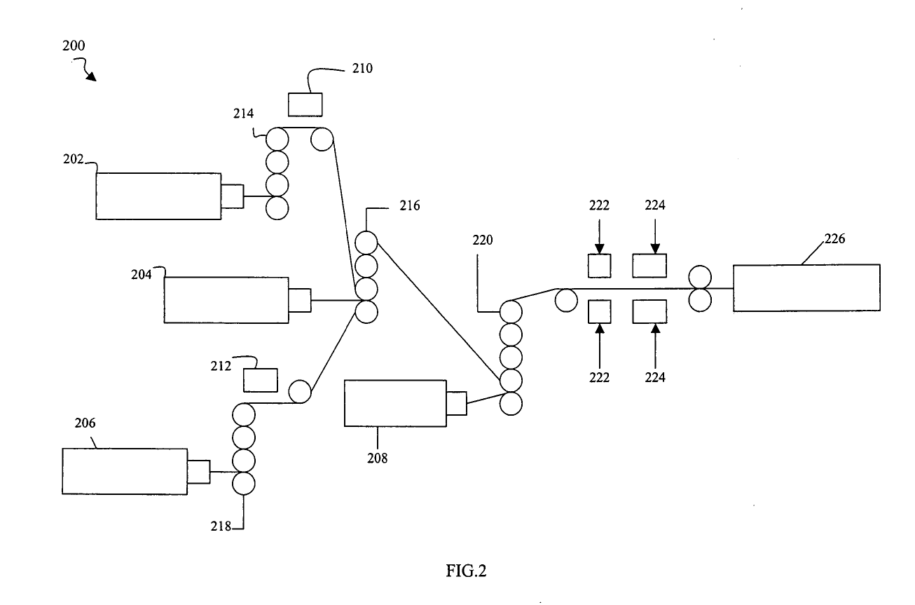

Referring to FIG. 2, another embodiment of a process line 200 that can be used in the methods of the present invention is shown comprising a plurality of first station extruders 202, 204, 206, a second station extruder 208, and a plurality of shaping stations 210, 212. As shown in FIG. 2, first station extruder 202 can be associated with shaping station 210, while first station extruder 206 can be associated with shaping station 212. Additionally, first station extruders 202, 206 can be associated with cooling stations 214, 218 such that the extruded composites formed by first extruders 202, 206 can be directed to a cooling station to cool the composites for further processing. Additionally, as described below, the extruded composite webs formed by first extruders 202, 204, 206 can be directed to lamination roll 216, which can facilitate combining the layers to form a composite layer. In some embodiments, lamination roll 216 can comprise a heating element that can heat to composite layers during the lamination process. Additionally, second station extruder 208 can be associated with a lamination roll 220, which facilitates laminating the composites formed by first extruders 202, 204, 206 and second extruder 208 to form a composite structure. In some embodiments, cooling stations 214, 218, and lamination rolls 216, 220 can comprise a series of rollers, which can also calendar the extruded composites such that the thickness of the composites can be adjusted by the cooling stations and/or lamination rolls. Furthermore, both cooling stations 214, 18 and lamination rolls 216, 220 can be hydraulically pressurized. As shown in FIG. 2, process line 200 can further comprise one or more surface treatment stations 222, stamp out station 224, and packaging station 226.

In general, as shown in FIG. 2, two stations of extruders can be provided such that separate combinations (i.e. laminations) can be performed, with surface modifications such as surface treatments, shaping processes and the like being performed before, after and/or between combination steps. For example, the plurality of first station extruders can produce a plurality of extruded composite layers which can be combined, by lamination or the like, to form a multi-layer bipolar plate. In some embodiments, reactant flow lines can be formed into the surface of one or more of the layers before the layers are combined, while in other embodiments reactant flow lines can be formed into a surface of one or more of the layer after the layers have been combined to form the multi-layer structure. In some embodiments, the flow channels can be formed by punching through one composite layer and combining the layer with a second layer. In other words, the layer stamped out, or punched through, defines the depth of the flow channels while the second layer becomes a base of the channel. In addition, the second station extruder(s) can extrude a membrane electrode assembly, which can be combined with the multi-layer bipolar plate to form a bipolar plate/membrane electrode assembly composite. Although, FIG. 2. shows an embodiment where the multi-layer bipolar plate is produced by combining three layers, embodiments are contemplated where the multi-layer bipolar plate comprises 2, 4 or 5 layers which are laminated together to form a final multi-layer bipolar plate.

Generally, polymer and at least one additive can be introduced into each of the plurality of first station extruders 202, 204, 206 such that a plurality of first polymer/additive composite layers can be formed. As described below, the plurality of first composite layers formed by the plurality of first extruders 202, 204, 206 can be coupled together to form a unitary structure by feeding the plurality of extruded composites to a common cooling station and/or lamination roll. In one embodiment, the plurality of composite layers produced by first station extruders 202, 204, 206 can be combined to form a bipolar plate. Although FIG. 2 shows an embodiment employing three first extruders 202, 204, 206, one of ordinary skill in the art will recognize that process lines having, for example, two, four, five or more first station extruders are contemplated and are within the scope of the present disclosure.

In some embodiments, the composite layers produced by first extruders 202, 204, 206 can have the same composition, while in other embodiments one or more of the composite layers can be different. For example, in embodiments where it is desirable to have hydrophilic properties in the flow channels, the middle layer, which can form a base of the flow channels in embodiments where the channels are formed by cutting entirely through the outside layers, can be formulated with a hydrophilic group such as, for example, a polyamide, while the outside layers can be formulated with other polymers. Additionally, in some embodiments the outside composite layers can be formulated with a relatively expensive conductive additive such as carbon nanotubes, while the inner layer(s) can be formulated with less expensive carbon powders. In other embodiments, one or more of the layers can have a carbon fiber mat adhered to one side of the layer to increase conductivity of the composite. In further embodiments, the middle layer can comprise a carbon mat that is coated on both sides with a conductive polymer to form bipolar plate structure. Suitable conductive polymers include, for example, polypyroles and Calgon conductive polymer 261 (commercially available from Calgon Corporation, Inc., Pittsburgh, Pa.).

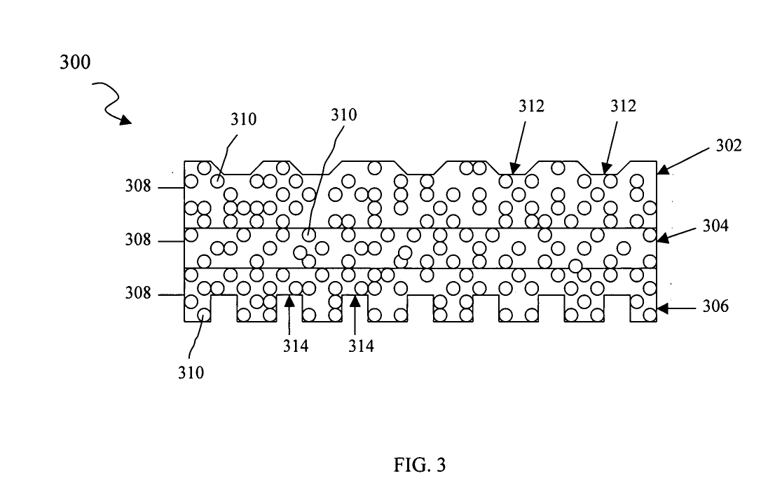

Referring to FIG. 3, as described above, the plurality of composite layers extruded by first station extruders 202, 204, 206 can be combined to form multi-layer bipolar plate 300. As shown in FIG. 3, bipolar plate 300 can comprise first layer 302, second layer 304 and third layer 306. Generally, each layer 302, 304, 306 can comprise a polymer binder 308 and conductive particles 310 located within the polymer binder. In some embodiments, polymer binder 308 can be the same polymer employed in all three layers 302, 304, 306, while in other embodiments different polymer can be used to form layers 302, 304, 306. Suitable polymers are described below. First layer 302 can have flow channels 312 formed into the surface of first layer 302, while third layer 306 can have flow channels 314 formed into the surface of third layer 306. In some embodiments, flow channels 312, 314 can be formed by punching or cutting through layers 302, 306, and laminating layers 302, 306 to layer 304.

Referring to FIG. 2, each of the plurality of composite layers formed by first station extruders 202, 204, 206 can be directed to further processing stations to facilitate shaping and combination of the composite layers. As shown in FIG. 2, shaping stations 210, 212 can be associated with first station extruders 202, 206, respectively, which allows desired shapes such as, for example, flow channels to be formed into one or more surfaces of the composites layers extruded by first station extruders 202, 206. In some embodiments, the extruded composite formed by extruder 202 can be directed to shaping station 210 where shaping station 210 can form reactant flow channels 312 on first layer 302. Similarly, the composite formed by extruder 206 can be directed towards shaping station 212 where reactant flow channels 314 on third layer 306 can be formed.

In general, the plurality of composite layers formed by first station extruders 202, 204, 206 can be directed towards a common process element such as a cooling station or a lamination station to facilitate combination of the composite layers to form a unitary multi-layer structure. The plurality of first composite layers can be combined together by any means suitable for combining polymer layers including, for example, pressure lamination, heat lamination, adhesives or combinations thereof. As shown in FIG. 2, the composite layers formed by first extruders 202, 206 can be directed towards lamination roll 216 where the composite layers formed by the first station extruders 202, 206 can be combined with the composite layer produced by first station extruder 204. In these embodiments, lamination roll 216 can comprise a series of rollers, which can apply pressure to the plurality of composite layers such that the composite layers can be pressured laminated together to form a unitary multi-layer structure, such as, for example, the bipolar plate shown FIG. 3. Although FIG. 2 shows an embodiment where the composites formed by first station extruders 202, 206 are shaped prior to being combined with the extruded composite formed by extruder 204, one of ordinary skill in the art will recognize that embodiments exist where the extruded composite are first combined to form a unitary structure and then directed to a shaping station where desired shaped can be formed into the composite surface.

Generally, process line 200 can further comprise second station extruder 208, which can extrude a second polymer/additive composite. As shown in FIG. 2, the second composite formed by second station extruder 208 can be directed towards lamination roll 220 where the second extruded composite can be combined with the composite produced by the plurality of first station extruders 202, 204, 206 to form a final composite material. In some embodiments, second extruder 208 can extrude an electrode assembly comprising a polymer binder and catalyst particles located within the polymer binder, wherein the catalyst particles are suitable for catalyzing electrochemical reactions. In other embodiments, second extruder 208 can extrude a membrane electrode assembly comprising an anode, a cathode and a separator positioned between the anode and the cathode. Additionally, process line 200 can optionally comprise one or more surface treatment stations 222, stamp out station 224 and packaging station 226, which can facilitate applying a surface treatment, stamping out the shaped article, and packaging the shaped article, respectively.

The process lines 100, 200 of the present disclosure generally employ one or more extruders to mix and form polymer/additive composites, which can then be further processed into articles having desired shape. The extruders employed in the process lines of the present disclosure can be any extruder suitable for forming a polymer/additive composites including, for example, single and twin screw extruders. Suitable commercial extruders include, for example, Berstorff model ZE or KE extruders (Hannover, Germany), Leistritz model ZSE or ESE extruders (Somerville, N.J.) and Davis-Standard mark series extruders (Pawcatuck, Conn.). Generally, polymer and one or more additives can be introduced into the extruders through appropriate injection ports such that the polymer and additive(s) can be mixed together to form a polymer/additive composite. In some embodiments, a fiber such as, for example, a carbon fiber can be introduced into extruder by fiber feed 112, which facilitates embedding the fiber within the polymer/additive composite. More specifically, a fiber can be pulled into the extruder such that the fiber can be simultaneously interweaved and impregnated into the composite web. As shown in FIG. 1, the fiber can be introduced into extruder 102 through die 103, however, in other embodiments the fiber can be introduced into the extruder through another injection port or other suitable opening. Suitable fibers are described below.

The die opening of the extruder dies employed in the process lines of the present disclosure can have any reasonable shape such as, for example, a slit, circle, oval or the like. Generally, the size and shape of the die opening can influence the characteristics of the composite for further processing. While the die opening can have a variety of possible shapes, in some embodiments, the die has a shape of a rectangular slit with a dimension corresponding to the thickness of the extrudate. Additionally, in some embodiments, desired thickness of the extruded composite can be obtained by calendering the extruded composition. Calendering broadly includes, for example, passing the extruded composition through a gap, generally formed by opposing pairs of moving members. Suitable moving members include, for example, rollers, belts and the like.

As shown in FIGS. 1 and 2, in some embodiments the extruded composites can be fed from an extruder to additional stations to facilitate further processing and shaping of the extruded composite. In some embodiments, the extruded composites can be directed to a cooling station comprising a series of rollers which can feed the extruded composite along a predetermined path, which allows the composite can be cooled by the ambient atmosphere. In other embodiments the cooling station can comprise a container having an inert liquid contained within the container. In these embodiments, the extruded composite can be fed through the container, and the inert liquid, which can cool the composite. In some embodiments, the extruded composite can be directed to the cooling station by a conveyer belt or the like, such that the extruded composite can be extruded onto the conveyer belt and directed towards the cooling station. In embodiments where the cooling station comprises a series of rollers, the rolling action of the rollers can pull the extruded composite out of the extruder and into the cooling station. Additionally, in embodiments where the cooling station comprises a series of rollers, the plurality of rollers can also calendar the composite such that the thickness of the composite can be adjusted at the cooling station. Moreover, the cooling station can help maintain uniform thickness and width of the extruded composite web

As described above, process lines 100, 200 generally comprise one or more shaping stations located along the process lines, which facilitate forming desired shapes into one or more surfaces of the extruded composite. In general, any shaping apparatus which can be integrated into a process line to provide continuous shaping of an extruded composite can be used in the processes of the present disclosure. The shaping station can comprise, for example, a laser machining station, a hot stamping station, one or more rollers, a photolithography station or combinations thereof. One of ordinary skill in the art will recognize that additional shaping devices are contemplated and are within the scope of the present disclosure. In embodiments where the shaped article comprises a bipolar plate, the shaping station can form flow channels, or grooves, into one or more surfaces of the extruded composite. Suitable designs for reactant flow channels are described in, for example, “Fuel Cell Systems Explained,” 2^{nd} Ed., Larmine, J., 2003, which is hereby incorporated by reference herein. One of ordinary skill in the art will recognize that the orientation, size and shape of the flow channels can be guided by the intended application of a particular bipolar plate. Additionally, in some embodiments, the shaping station can also introduce perforations into the surface of the extruded composite, which can facilitate packaging multiple shaped articles in a roll configuration.

As described above, the shaping stations employed in process lines 100, 200 can comprise a laser machining station. Generally, laser machining of polymer composites involves exposing the polymer to intense laser pulses which can be absorbed by the polymer composite. Generally, the geometry of the etched pattern can be influenced by the shape of the light beam and the path the laser traces over the surface of the composite. Furthermore, the depth of the etching can be a function, in some embodiments an approximately linear function, of the number of laser pulses. In other embodiments, the laser can cut entirely through the polymer composite, which facilitates the formation of, for example, grooves when the cut composite is laminated to another composite layer. Laser machining of composites can facilitate the formation of shaped articles with strict tolerances since the laser path and depth can be precisely controlled. Additionally, laser machining can also permit continuous processing, since the composite can be extruded and directly shaped into a desired article, which can reduce the costs associated with producing shaped articles. Furthermore, shaping the extruded composite by laser machining permits relatively quick adjustments and/or changes to be made to the shaping process or pattern, since the laser path, depth and intensity can be controlled and varied without replacing the laser machining station itself. Thus, laser machining can permit a single process line to manufacture shaped articles having different patters or shapes on the surface of the articles without the need to exchange or replace process equipment. Suitable laser machining devices include, for example, Votan by Jenoptik (Jenna, Germany) and DP100-532 by Oxford Lasers (Littleton, Mass.). In some embodiments, the laser can comprise, for example, a carbon dioxide infrared laser having a wavelength of about 10.6 micrometers. Additionally, the laser can have, for example, a range of power from about 20 W to about 1250 W. Suitable infrared optics are commercially available to focus and/or direct the beam.

In some embodiments, the laser can be placed directly above and/or below the extruded polymer/additive composite such that the laser pulses can be directed towards desired surfaces of the polymer/additive composite. The laser machining station can further comprise an optical system having one or more scanning mirrors and/or one or more lenses for moving and/or focusing the path of the laser around the surface of the composite. For example, the mirror can be connected to stepper motors, which can move the mirrors such that the laser beam can be redirected by the mirrors to contact desired surfaces of the extruded composite. Laser machining systems and optical systems suitable for use in laser machining are described in U.S. Pat. No. 6,586,703 to Isaji et al., entitled “Laser Machining Method, Laser Machining Apparatus, And Its Control Method,” and U.S. Pat. No. 6,635,850 to Amako et al., entitled “Laser Machining Method For Precision Machining,” both of which are hereby incorporated by reference herein.

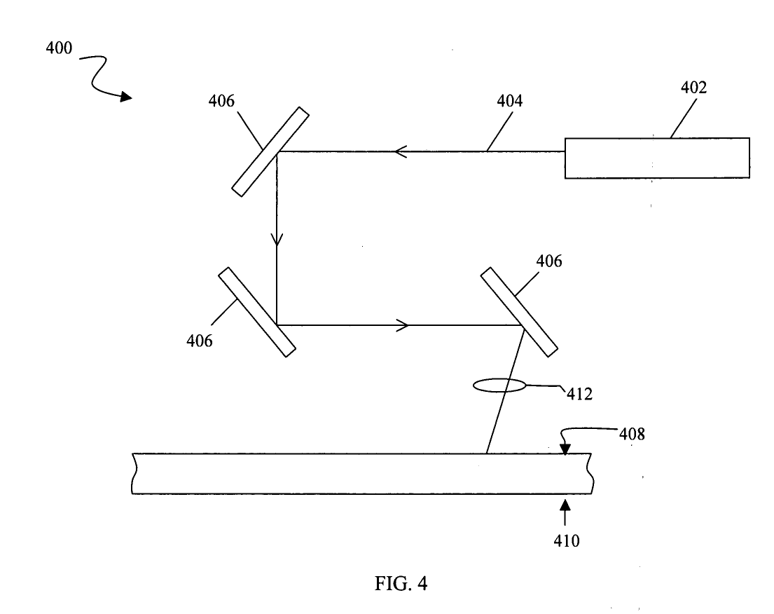

Referring to FIG. 4, an embodiment of a laser machining station 400 is shown comprising laser generator 402 which can generate laser beam 404. Additionally, laser machining station 400 can comprise a plurality of scanning mirrors 406 suitable for redirecting laser beam 402 onto first surface 408 of the continuous polymer/conductive polymer additive web. In some embodiments, a second laser machining station can be positioned such that a laser beam can be directed towards second surface 410 of the continuous polymer/conductive polymer additive web. As described above, the plurality of scanning mirrors 406 can be moved and/or rotated such that laser beam 404 can be directed along a desired portion of surface 408. In some embodiments, lens 412 can be provided to move and or focus laser beam 404 onto desired portions of surface 408.

Additionally or alternatively, a mask can be positioned between the polymer/additive composite and the laser, the mask having a predetermined cut out pattern through the mask which permits light to pass through the cut out section. Due to the predetermined cut out pattern, a portion of the laser beam can pass though the cut out section of the mask, while other portions of the laser beam contact the mask and are blocked from contacting the polymer/additive composite. In other words, the mask allows only the portion of the laser beam located within the predetermined pattern to contact the polymer/additive composite, which can etch the predetermined pattern into the surface of the polymer additive composite. In general, the depth of the etchings formed into the composite surface can be controlled by varying the intensity and/or number of laser pulses directed at a particular surface of the composite. A person of ordinary skill in the art can adjust the laser parameters empirically based on the disclosure herein to obtain the desired degree of cutting.

In embodiments where the extruded composite comprise a sheet, the laser machining apparatus can form perforations into the surface of extruded composite between adjacent shaped articles, which allow the shaped articles to be packaged in a roll such that individual shaped articles can be removed from the packaged by tearing/cutting along the perforations. For example, in some embodiments, the perforations can be formed in a line across the surface of the composite web. In other embodiments, the perforations can be formed by a separate apparatus such as a mechanical press or the like. For example, in embodiments where the shaped article comprises a bipolar plate, the perforations can be positioned between adjacent plates such that the bipolar plates can be packaged in a roll, and individual bipolar plate can be obtained by tearing along one of the perforations.

In other embodiments, desired shape can be formed into the surface of the extruded composite web by a photolithography process. In general, a photoresist chemical can be applied to desired surfaces of the extruded composite web to form a composite/photoresist combination. In some embodiments, desired surfaces of the composite/photoresist combination can then be exposed to UV light, which can cause the photoresist to cure, or polymerize, which can make the photoresist more inert on the surface of the composite web. Generally, a mask or the like can be placed between the UV light source and the composite/photoresist combination such that UV light only contacts desired surfaces of the combination. Finally, a developer solution can be used to wash away uncured photoresist, which can leave the cured, or polymerized, photoresist on the surface of the composite web. Thus, the cured photoresist can form structure such as, for example, the walls of flow channels on the surface of the extruded composite web. In these embodiments, the photoresist can be applied to the composite web such that the thickness of the photoresist generally corresponds to the desired depth of the flow channel walls. In some embodiments, the UV light source can move along the web to cure desired portions of the photoresist as the composite web is moving along the process line. Photolithography is generally described in U.S. Pat. No. 4,945,028 to Ogawa, entitled “Method For Formation Of Patterns Using High Energy Beam,” U.S. Pat. No. 6,475,682 to Priestley et al., entitled “Photolithography Method, Photolithography Mask Blanks, And Method Of Making,” and U.S. Pat. No. 6,376,292 to Youn et al., entitled “Self-Aligning Photolithography And Method Of Fabricating Semiconductor Device Using The Same,” all of which are hereby incorporated by reference herein.

As described above, the shaping station employed in the process lines of the present disclosure can comprise a hot stamping station and/or one or more rollers having a predetermined pattern on the surface of the rollers. In some embodiments, the hot stamping station having one or more stamps with a predetermined pattern located on a surface stamps. In these embodiments, as the polymer/additive composite is directed from the extruder, the hot stamp can contact the extruded composite and stamp a desired pattern into one or more surfaces of the composite. For example, one hot stamp can be located above the extruded composite and a second hot stamp can be located below the composite, which facilitates shaping two surfaces of the composite essentially simultaneously. In some embodiments, both the stamp located above the composite and the stamp located below the composite can have the same pattern, while in other embodiments the stamps can have different patterns. In other embodiments, the hot stamping station can comprise a mechanical element that punches through the extruded composite such that when the composite is laminated to another composite layer or surface, desired structure such as, for example, a groove is formed.

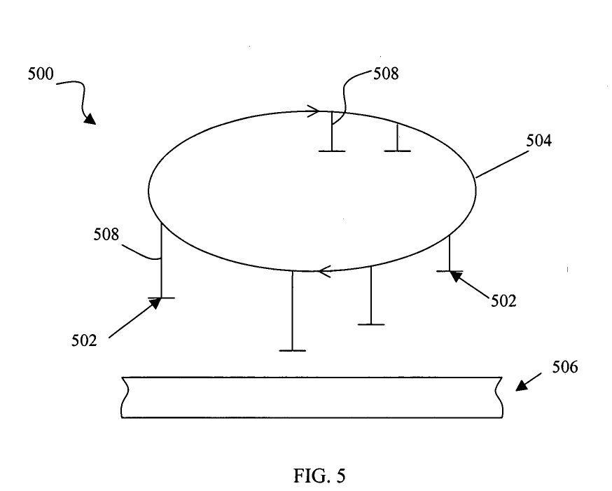

Referring to FIG. 5, in one embodiment, the hot stamping apparatus 500 can comprise a plurality of stamping plates 502 connected to a rotary 504 that is rotating with a linear surface speed at approximately the speed of the extruded composite web 506. Generally, the plurality of stamping plates 502 can be connected to rotary 504 by drive shafts 508 or the like, which can facilitate lowering the stamping plates 502 to contact a surface of composite web 506. In some embodiments, as a stamp plate is rotated over the surface of the moving composite, the drive shaft associated with that plate can lower the stamp plate to contact the composite web. The stamp can be lowered at intervals to press a structure from the rotary to the web. The rotary contours a section of the linear web based on the radius of curvature of the rotary, the pressure, the shape of the contours on the rotary, and the elasticity of the materials. If the lowing and raising of the rotary is performed quickly relative to the other motions in the system, the interval of stamping can be based on the length of web contoured in one stamp and the linear speed of the web. The rotary can be continuously rotated with only minor interruption of the rotation due to the stamping process, which can be accounted for, or incremental rotation of the rotary, for example, using a stepper motor or the like.

Additionally, the shaping station can optionally comprise one or more rollers having a predetermined shape on the surface of the roller, which can transfer the predetermined patter to the composite as the composite contacts the surface of the rollers. Rollers having a predetermined pattern for forming grooves onto the surface of a composite are described in U.S. Published Patent Application No. 2002/0127464, filed on Dec. 26, 2001, entitled “Separator For Fuel Cell, Method For Producing Separator And Fuel Cell Applied With Separator,” which is hereby incorporated by reference herein.

As described above, process lines 100, 200 of the present disclosure can optionally comprise one or more surface treatment stations, which can apply a surface treatment to one or more surfaces of the extruded composite. Generally, the surface treatment station can apply any surface treatment suitable for extruded composites such as, for example, surface coatings and/or irradiation to promote cross-linking. In some embodiments, the surface treatment station can comprise a coating station suitable for applying coatings such as, for example, a conductive coating, an abrasion resistance coating, a non-stick coating such as fluoropolymer or the like, or combinations thereof. The coating station can comprise any appropriate means for coating including spraying devices, submerging devices and combinations thereof.

In embodiments having a conductive coating on the surface of the shaped article, the conductive coating can be applied by, for example, coating the shaped article with a mixture comprising a conductive polymer dissolved in a suitable solvent. The conductive polymer/solvent mixture can be applied to an appropriate surface(s) of the extruded composite, and when the solvent evaporates a conductive coating can be deposited on the shaped article. Generally, the choice of solvent will depend on the specific conductive polymer being used. The solvent used to dissolve the conductive polymer should be selected such that the solvent will not degrade the shaped article during the coating process. In some embodiments, the conductive polymer can comprise a polymer matrix having carbon nanotubes located within the polymer matrix. The carbon nanotubes can be mixed throughout the polymer matrix and/or can be covalently bonded to the polymer matrix. Polymers/carbon nanotubes composites are described in U.S. patent application Ser. No. 10/784,322, entitled “Compositions Comprising Carbon Nanotubes And Articles Formed Therefrom, which is hereby incorporated by reference herein. In other embodiments the surface treatment stations can apply a coating to increase the lyophilicity of desired surfaces, such as flow channel walls, of the composite. Coatings that can increase the lyophilicity of materials are disclosed in copending U.S. patent application Ser. No. 10/______, Extrand et al., filed on the same day as the present application, entitled “Fuel Cell Component With Lyophilic Surface,” and U.S. patent application Ser. No. 10/______, Extrand et al., filed on the same day as the present application, entitled “Lyophilic Fuel Cell Component,” both of which is hereby incorporated by reference herein. In further embodiments, the coating can be a fluoropolymer coating comprising a fluoropolymer, such as, for example poly(tetraflurorethylene), dissolved in a suitable solvent. The fluoropolymer/solvent mixture can then be applied to desired surfaces of the composite web, which can result in a fluoropolymer coating once the solvent evaporates. Additionally, the coating can comprise an abrasion resistance coating such as a polyurethane layer, which can be applied by dissolving the polyurethane in a suitable solvent and applying the resulting mixture to desired surfaces of the composite web.

Additionally or alternatively, the surface treatment station can comprise a cross-linking station which can promote cross-linking of desired surfaces of the composite. It is known that gamma radiation, ultra violet (UV) light and e-beams can promote cross-linking of polymers, and thus the cross-linking station can comprise a gamma radiation emitter, a UV light source, an e-beam source or combinations thereof. In some embodiments, process lines 100, 200 can comprises a plurality cross-linking stations which permits multiple surfaces of the extruded composite to be cross-linked essentially simultaneously. UV emitters are commercially available from Heraeus Noblelight LLC (Duluth, Ga.).

Process lines 100, 200 can also comprise a stamp out station and/or a packaging station, which can stamp or cut out the shaped portion of the extruded composite web to form a shaped article and package the shaped article in an appropriate container, respectively. In general, any cutting or stamping apparatus suitable for cutting shaped articles out of extruded composites can be incorporated into the process lines of the present disclosure. Additionally, the packaging station can transfer the shaped article to an appropriate container and seal the container. In embodiments where perforations have been formed between adjacent articles, the packaging station can packaged the shaped articles in a roll such that individual shaped articles can be obtained by unrolling a shaped article and tearing along the preformed perforations. In some embodiments, the packaging station can roll up the extruded composite web and directly package the rolled web in a suitable container without cutting the web prior to packaging.

As shown in FIG. 1, in some embodiments, process line 100 can optionally comprise grinder 114 and regrind loop 116, which facilitates recycling of unused composite material back into extruder 102. Generally, grinder 114 can be any mechanical device suitable for grinding or crushing an extruded composite into composite particles. As shown in FIG. 1, grinder 114 can be located at the end of process line 100 such that extruded composite material that is left behind after the shaped article is cut or stamped out of the extruded composite can be ground into composite particles. The composite particles can then be transported via regrind loop 116 to extruder 102, where the composite particles can be combined with new polymer and additives to form an extruded composite.

Polymer/Additive Composites

As described above, the methods of the present disclosure generally comprise forming and extruding one or more polymer/additive composites, and subsequently shaping the polymer/additive composite to form a shaped article. Additionally, a fiber such as a carbon fiber can be incorporated into the polymer/additive composite to increase the mechanical strength, durability and/or conductivity of the composite. In some embodiments, the extruded polymer/additive composite can comprise a sheet having a generally planar aspect with a thickness that is significantly smaller than the dimensions across the face of the sheet, however, no particular shape of the extruded composite required by the present disclosure. Generally, the mechanical and electrical properties of the composite can be adjusted by selecting appropriate polymer and additives such that shaped articles produced by the methods of the present disclosure can exhibit a range of mechanical and electrical properties.

The polymers used to form the polymer/additive composite can be any polymer that can be mixed and combined with at least one additive in an extruder to form a polymer/additive composite. The polymer can be a homopolymer, copolymer, block copolymer or blends thereof. Suitable polymers include, for example, poly(tetrafluoroethylene), poly(vinylidenefluoride), perfluoroalkoxy tetrafluoroethylene (PFA), poly(vinylchloride) (PVC), polyethylene, ultra high molecular weight polyethylene (UHMWPE), polypropylene, poly(ethylene terephthalate glycol), polycarbonate, polyolefins (PO), styrene block co-polymers (e.g. Kraton®), styrene-butadiene rubber, nylon in the form of polyether block polyamide (PEBA), polyetheretherketone (PEEK), ethyl vinyl acetate, polyurethanes, polyimides and copolymers and mixtures thereof.

The additives incorporated into the polymer/additive composite can be, for example, an additive that increases the mechanical strength of the polymer, an additive that increases the electrical conductivity of the polymer, or combinations thereof. For example, electrically conductive additives can comprise carbon conductors, such as, carbon black, carbon nanotubes, other carbon particles, conductive fibers, metal particles, ceramics and combinations thereof. Suitable conductive fibers include, for example, Sigrafil® made by SGL Carbon (Wiesbaden, Germany), Kynol™ made by American Kynol, Inc. (Pleasantville, N.Y.) and Panex® made by Zoltek, Inc. (St. Louis, Mo.). Suitable carbon blacks can include, for example, acetylene blacks, furnace blacks, thermal blacks and modified carbon blacks. Specific suitable carbon blacks include, for example, ABC-55 22913 (Chevron Phillips, Houston, Tex.), Blacks Pearls (Cabot, Billerica, Mass.), Ketjen Black (Akzo Nobel Chemicals Inc., Chicago, Ill.), Super-P (MMM Carbon Division, Brussels, Belgium), Condutex 975® (Columbia Chemical Co., Atlanta, Ga.) and combinations thereof.

In general, the shaped articles are formed from a composite comprising polymer and at least one additive such as, for example, conductive carbon. In some embodiments, the additives are present in a concentration less than about 95 percent by weight. In other embodiments, the additives are present in a concentration from about 20 percent by weight to about 80 percent by weight, and in further embodiments from about 30 percent by to about 60 percent by weight. One of ordinary skill in the art will recognize that additional ranges within these explicit ranges are contemplated and are within the scope of the present disclosure.

In some embodiments, a fiber, such as a carbon fiber can be incorporated into the polymer/additive composite to increase the mechanical strength of the composite and/or to increase the electrical conductivity of the composite. Generally, carbon fibers are chemically resistant, rigid structures that can be used to produce articles such as, for example, tennis rackets, bicycles and golf clubs. Carbon fibers can be produced from organic polymers such as, for example, poly(acrylonitrile) that are stretched and oxidized to produce precursor fibers. The precursor fibers can then be heated in a nitrogen environment, which facilitates the release of volatile compounds and yields fibers that are primarily composed of carbon. Carbon fibers are commercially available in varying grades, which can have varying tensile strengths and weights. As used herein, carbon fibers can be a range of carbon fiber materials including, for example, carbon nanotubes. Carbon nanotubes are rolled up graphene sheets of carbon which exhibit useful mechanical and electrical properties. Generally, carbon nanotubes are described as comprising tubular graphene walls which are parallel to the filament axis. Carbon nanotubes can exist as single and multiple wall structures, both of which are commercially available. For example, single wall carbon nanotubes are available from CarboLex (Lexington, Ky.) and Carbon Nanotechnologies, Inc. (Houston, Tex.), and multiple wall carbon nanotubes are available from Applied Sciences Inc. (Cedarville, Ohio). Additionally, carbon nanotubes can be hollow and can have end caps which seal the tubular structure.

In some embodiments, the carbon nanotubes can incorporated into dispersions to facilitate processing of the nanotubes into the polymer/additive composite. For example, an aqueous dispersion of carbon nanotubes in ethyl vinyl acetate can be formed and the ethyl vinyl acetate/carbon nanotube dispersion can be introduced into an extruder, which allows the carbon nanotubes to be incorporated into the polymer/additive composite. Ethyl vinyl acetate is sold commercially under the trade name Bynel® (Dupont, Wilmington, Del.), under the trade name Plexar® (Equistar, Houston, Tex.), and under the trade name Evatane® (Atofina Chemicals, Philadelphia, Pa.). Carbonn nanotubes composites and forming dispersions of carbon nanotubes in ethyl vinyl acetate are described in U.S. patent application Ser. No. 10/784,322, filed on Feb. 23, 2004, entitled “Compositions Comprising Carbon Nanotubes And Articles Formed Therefrom,” which is hereby incorporated by reference herein.

In embodiments where a fiber such as, for example, a carbon fiber is incorporated into the polymer/additive composite, the fiber can be present in a concentration from about 1 percent by weight to about 50 percent by weight. In other embodiments, the fiber can be present in a concentration from about 5 by weight to about 40 percent by weight. One of ordinary skill in the art will recognize that additional ranges within these explicit ranges are contemplated and are within the scope of the present disclosure.

Additionally, optional processing aids such as, for example, fillers, stabilizers, surfactants and the like can optionally be introduced into the extruders through an injection port such that the processing aids can be combined with the polymer and additive(s) during formation of the polymer/additive composite. Generally, the optional processing aids are present in a concentration of no more than 5 weight percent.

Forming Polymer/Additive Composites and Shaped Articles

The shaped articles of the present disclosure can be made by a continuous process where a polymer/additive composite is formed and shaped on a single process line, which can reduce the time and expenses associated with manufacturing shaped articles. In some embodiments, polymer and one or more additives are added directly to an extruder without a pellet forming or pre-mix step in which the components of the composite are combined prior to introduction into the extruder. By eliminating the pre-mix step, the methods of the present disclosure can reduced the time and expenses associated with manufacturing shaped articles. In some embodiments, if the extruder can provide suitable shear forces to mix the additives throughout the polymer, the pre-mix step can be eliminated and the components of the composition can be directly introduced into an extruder. Additionally, the high shear mixing provided by the extruder can facilitate good mixing of the one or more additives throughout the polymer, which can result in the formation of composite materials having suitable mechanical and electrical properties. As described above, the composite material can be formed into articles having desired shape by the shaping stations located along process lines 100, 200.

During operation of process lines of the present disclosure, desired amounts of polymer and one or more additives, along with any optional processing aids, can be introduced into and mixed by the extruders. As described above, in some embodiments, a fiber feed can introduce a fiber, such as a carbon fiber, into the extruders, which permits the fiber to be incorporated into the polymer/additive composite. The mixing of the components by the extruders facilitates the formation of a polymer/additive composite which can be extruded out of extruder dies. In embodiments where the additive comprises a conductive additive, the extruders can promote good mixing of the additive throughout the polymer such that good conductivity through the polymer is obtained. In some embodiments, the extruded composite can be a sheet having a generally planar aspect with a thickness that is significantly smaller than the dimensions across the face of the sheet.

In some embodiments, the extrusion to form the polymer/additive composite can be performed at pressures in the range from about 500 psig to about 5000 psig. One of ordinary skill in the art will recognize that additional ranges of extrusion pressures within this explicit range are contemplated and are within the scope of the present disclosure. In general, the extrusion can be performed at any temperature to permit suitable mixing of the additive throughout the polymer. In some embodiments, the extrusion can be performed at room temperature, while in other embodiments the extrusion can be performed at an elevated temperature. In embodiments where the extrusion is performed at an elevated temperature, the temperature can be in the range(s) from about 25° C. to about 250° C., in other embodiments from about 50° C. to about 200° C. and in further embodiments form about 75° C. to about 150° C. A person of ordinary skill in the art will recognize that additional rages of extrusion temperatures within these explicit ranges are contemplated and are within the scope of the present disclosure.

As the extruded composite exists the extruders, the composite web can be directed to a cooling stack where the extruded composite can be cooled. Additionally, if the cooling stack comprises a series of rollers, the rollers can calender the composite and adjust the thickness of the extruded composite web. In some embodiments, the thickness of the composite web can be in the range(s) of from about 0.005 inches to about 0.050 inches, while in other embodiments the extruded composite web can have a thickness in the range(s) of from about 0.010 inches to about 0.030 inches.

Generally, desired shapes can be introduced into the surface of the extruded composite by one or more shaping stations located along the process lines. In embodiments where the shaped article comprises, for example, a bipolar plate, the shaping stations can introduce flow channels or grooves into one or more surfaces of the extruded composite. In some embodiments, the reactant flow channels can be formed on two opposite surfaces of the composite to facilitate delivery of reactants to the anode of one cell and the cathode of an adjacent cell. In some embodiments, the flow channels on each surface can have the same pattern, while in other embodiments the flow channels on one surface can have different pattern than the flow channels on the opposite surface. As described above, forming, for example, flow channels into a composite using laser machining permits a single process line to produce several different bipolar plates, since the flow channel pattern can be adjust be varying the laser path, intensity and depth.

As described above, the shaping of the extruded composite can be conducted in a continuous manner, which can reduce the time and expense associated with producing shaped articles. In embodiments where the shaping is produced by a laser machining apparatus, the complexity of the shapes formed into the surface of the composite can guide the speed of the extruded composite moving along the process line. For example, relatively simple shapes, such as linear flow lines, require less redirection of the laser beam, and thus the extruded composite can move at a relatively faster rate along the process line. In other embodiments, where more complex shapes, such as flow channels having a serpentine shape, are formed into the extruded composite, the extruded composite can move at a slower speed along the process line to permit redirection of the laser beam over desired surfaces of the composite.

In some embodiments, the method of the present disclosure can further comprise treating one or more surfaces of the extruded composite. As described above, the process lines of the present disclosure can optionally comprise surface treatment stations, which can treat one or more surfaces of the extruded composite. Generally, the surface treatment stations can applying a surface treatment before and/or after the extruded composite has been shaped by one or more shaping stations. As described above, the surface treatment stations can, for example, apply one or more coatings to desired surfaces of the composite and/or promote cross-linking of desired surfaces. Additionally, one or more coatings may be applied to the same surface of the composite to impart desired properties to the selected surfaces of the extruded composite.

Additionally, unused composite material that is left behind after the shaped article has been cut or stamped out of the extruded composite sheet can be feed into a grinder located along the process line such that the extruded composite can be ground into a particulate material. As shown in FIG. 1, the particulate material can then be transported, via regrind loop 116, to extruder 102 where the particulate material can be combined with incoming polymer and additives such that the particulate composite material can be incorporated into a new polymer/additive composite.

In some embodiments, the final bipolar plates can be laminated to an adhesive film to enable high volume manufacturing of fuel cell stacks. For example, the adhesive film can allow automated process equipment to easily attach the bipolar plates to a electrode assembly, which can facilitate the formation of fuel cell stacks. In one embodiment, the bipolar plates/adhesive combination can be supplied on a reel attached to a manufacturing line, which permits the plate/adhesive combination to be peeled off of a backing layer and positioned in a fuel cell stack. Additionally, as described above, the plates can be provided in a roll configuration with perforations formed between adjacent plates, which can facilitate easy tearing off of individual bipolar plates from the roll such that the roll configuration can be used in automated fuel cell manufacturing operations.

The above embodiments are intended to be illustrative and not limiting. Additional embodiments are within the claims. Although the present invention has been described with reference to particular embodiments, workers skilled in the art will recognize that changes may be made in form and detail without departing from the spirit and scope of the invention.

1. A method for forming a bipolar plate for a fuel cell, the method comprising:
laser machining a continuous web of a polymer/conductive polymer additive composite to form first flow channels on a surface of the composite web, wherein the polymer/conductive polymer additive composite comprises a first surface and a second surface, and wherein the first flow channels are formed into the first surface.

2. The method claim 1 further comprising laser machining the polymer/conductive polymer additive composite such that second flow channels are formed into the second surface of the composite.

3. The method of claim 2 wherein the first flow channels formed into the first surface are equivalent to the second flow channels formed into the second surface of the composite.

4. The method of claim 2 wherein the first flow channels formed into the first surface are different from the second flow channels formed into the second surface of the composite.

5. The method of claim 1 further comprising applying a surface treatment to a surface of the polymer/conductive polymer additive composite.

6. The method of claim 5 wherein applying the surface treatment comprises applying a surface coating to at least one surface of the polymer/conductive additive composite web.

7. The method of claim 6 wherein the surface treatment is selected from the group consisting of abrasion resistance coatings, fluoropolymer coatings, conductive coatings, coatings that improve lyophilicity and combinations thereof.

8. The method of claim 5 wherein applying the surface treatment comprises cross-linking of a surface of the polymer/conductive additive composite web.

9. The method of claim 8 wherein the surface of the polymer/conductive polymer additive composite web is cross-linked by exposing the surface to UV light, e-beam radiation, gamma radiation or combinations thereof.

10. The method of claim 1 further comprising cutting a desired portion of the composite web to form a bipolar plate.

11. The method of claim 10 further comprising packaging the bipolar plate in a container.

12. The method of claim 10 further comprising grinding up the polymer/conductive polymer additive composite material left behind after the desired portion has been cut out to form composite particles, and recycling the composite particles back into an extruder.

13. The method of claim 1 further comprising forming perforations into a surface of the polymer/conductive polymer additive composite web.

14. The method of claim 13 further comprising packaging the bipolar plates in a roll configuration such that individual bipolar plates can be obtained by tearing along one of the perforations.

15. The method of claim 1 further comprising introducing a fiber into the polymer/conductive polymer additive composite.

16. The method of claim 15 wherein the fiber comprises carbon fibers.

17. The method of claim 1 wherein the polymer is selected from the group consisting of poly(tetrafluoroethylene), poly(vinylidenefluoride), polyetheretherketone (PEEK), polyethylene, ultra high molecular weight polyethylene (UHMWPE), polycarbonate, polyolefins (PO), styrene block co-polymers (e.g. Kraton®), styrene-butadiene rubber, nylon in the form of polyether block polyamide (PEBA), ethyl vinyl acetate, polyurethane, polypropylene, poly(ethylene terephthalate glycol) poly(vinylchloride) (PVC), polyimides and mixtures and copolymers thereof.

18. The method of claim 1 wherein the conductive additive is selected from the group consisting of carbon particles, metal particles, ceramics and combinations thereof.

19. The method of claim 1 wherein the continuous polymer/conductive polymer additive composite is formed by introducing polymer and at least one conductive additive into an extruder, and extruding a polymer/conductive polymer additive composite web.

20. The method of claim 19 wherein the extruder comprises a twin-screw extruder.

21. The method of claim 19 further comprising directing the extruded polymer/conductive polymer additive composite web to a cooling station where the composite can be cooled to facilitate further processing of the composite.

22. The method of claim 21 wherein the cooling station comprises a series of rollers, which directs the extruded polymer/conductive polymer additive composite web along a predetermined path.

23. The method of claim 22 wherein the series of rollers calenders the extruded polymer/conductive additive composite web such that a desired thickness of the composite web is obtained.

24. A method of forming a bipolar plate for a fuel cell, the method comprising:
hot stamping a continuous web of a polymer/conductive polymer additive composite to form first flow channels on a surface of the composite web, wherein the polymer/conductive polymer additive comprises a first surface and a second surface, and wherein the first flow channels are formed into the first surface.

25. The method claim 24 further comprising hot stamping the polymer/conductive polymer additive composite such that second flow channels are formed into the second surface of the composite.

26. The method of claim 25 wherein the first flow channels formed into the first surface are equivalent to the second flow channels formed into the second surface of the composite.

27. The method of claim 25 wherein the first flow channels formed into the first surface are different than the second flow channels formed into the second surface of the composite.

28. The method of claim 24 further comprising applying a surface treatment to a surface of the polymer/conductive polymer additive composite web.

29. The method of claim 28 wherein applying the surface treatment comprises applying a surface coating to a surface of the polymer/conductive polymer additive composite web.

30. The method of claim 29 wherein the surface treatment is selected from the group consisting of abrasion resistance coatings, fluoropolymer coatings, conductive coatings, coatings that improve lyophilicity and combinations thereof.

31. The method of claim 28 wherein the surface treatment comprises cross-linking a surface of the polymer/conductive additive composite web.

32. The method of claim 31 wherein the surface of the polymer/conductive polymer additive web is cross-linked by exposing the surface to UV light, e-beam radiation, gamma radiation or combinations thereof.

33. The method of claim 24 further comprising cutting a desired portion of the composite web to form a bipolar plate.

34. The method of claim 33 further comprising packaging the bipolar plates in a container.

35. The method of claim 33 further comprising grinding up composite material left behind after the desired portion has been cut out to form composite particles, and recycling the composite particles back into an extruder.

36. The method of claim 24 further comprising forming perforations into the surface of the extruded polymer/conductive polymer additive composite.

37. The method of claim 36 further comprising packaging the bipolar plates in a roll configuration such that individual bipolar plates can be obtained by tearing along one of the perforations.

38. The method of claim 24 further comprising introducing a fiber into the polymer/additive composite.

39. The method of claim 38 wherein the fiber comprises carbon fibers.

40. The method of claim 24 wherein the polymer is selected from the group consisting of poly(tetrafluoroethylene), poly(vinylidenefluoride), polyetheretherketone (PEEK), polyethylene, ultra high molecular weight polyethylene (UHMWPE), polycarbonate, polyolefins (PO), styrene block co-polymers (e.g. Kraton®), styrene-butadiene rubber, nylon in the form of polyether block polyamide (PEBA), ethyl vinyl acetate, polyurethane, polypropylene, poly(ethylene terephthalate glycol) poly(vinylchloride) (PVC), polyimides and mixtures and copolymers thereof.

41. The method of claim 24 wherein the conductive additive is selected from the group consisting of carbon particles, metal particles, ceramics and combinations thereof.

42. The method of claim 24 wherein the continuous polymer/conductive polymer additive composite is formed by introducing polymer and at least one conductive additive into an extruder, and extruding a polymer/conductive polymer additive composite web.

43. The method of claim 42 wherein the extruder comprises a twin-screw extruder.

44. The method of claim 42 further comprising directing the extruded polymer/conductive additive composite web to a cooling station where the composite web can be cooled to facilitate further processing of the composite.

45. The method of claim 44 wherein the cooling station comprises a series of rollers which directs the extruded polymer/conductive additive composite web along a predetermined path.

46. The method of claim 45 wherein the series of rollers calendar the extruded polymer/conductive polymer additive composite web such that a desired thickness of the composite web is obtained.

47. A method of forming a composite structure for a fuel cell comprising:
extruding a plurality of composite layers, wherein the plurality of composite layers each comprise a conductive additive and a polymeric binder;
forming reactant flow channels on the surface of at least one of the plurality of composite layers;
combining the plurality of composite layers to form a multi-layer bipolar plate;
extruding a membrane electrode assembly, wherein the membrane electrode assembly comprises an anode, a cathode and a separator between the anode and the cathode; and
combining the multi-layer bipolar plate and the membrane electrode assembly to form a membrane electrode assembly/bipolar plate composite.

48. The method of claim 47 wherein the flow channels are formed by laser machining.

49. The method of claim 47 wherein the flow channels are formed by a hot stamping apparatus.

50. The method of claim 47 wherein flow channels are formed into at least two of the plurality of composite layers.

51. The method of claim 47 wherein the plurality of composite layers are combined by pressure lamination, heat lamination, adhesive bonding or combinations thereof.

52. The method of claim 47 further comprising directing the plurality of extruded composites to a lamination roll such that the plurality of composite layer are pressure laminated to each other to form a multi-layer structure.

53. The method of claim 47 wherein the membrane electrode assembly and the multi-layer bipolar plate are combined by pressure lamination, heat lamination, adhesive bonding or combinations thereof.

54. The method of claim 47 further comprising applying a surface treatment to a surface of the bipolar plate/membrane electrode assembly composite.

55. The method of claim 54 wherein applying the surface treatment comprises applying a surface coating to a surface of the bipolar plate/membrane electrode assembly composite.

56. The method of claim 55 wherein the surface treatment comprises a fluoropolymer coating, an abrasion resistance coating, a conductive coating, a coating to improve lyophilicity or combinations thereof.

57. The method of claim 54 wherein the surface treatment comprises cross-linking a surface of the bipolar plate/membrane electrode assembly composite.

58. A method for forming shaped articles comprising:
extruding a composite web having a first surface and a second surface, the composite web comprising polymer and at least one electrically conductive additive; and
laser machining the composite web such that desired shaped is formed into at least one surface of the composite web.
